(19) United States
(12) Patent Application Publication
(10) Pub. No.: US 2008/0288500 A1
(43) Pub. Date: Nov. 20, 2008

(54) Physiological data processing architecture for situation awareness

(76) Inventor: Demetrios Sapounas, Leesburg, VA (US)

Correspondence Address: ARENT FOX LLP, 1050 CONNECTICUT AVENUE, N.W., SUITE 400, WASHINGTON, DC, 20036, US

(21) Appl. No.: 12/068,969

(22) Filed: Feb. 13, 2008

Related U.S. Application Data
(60) Provisional application No. 60/900,987, filed on Feb. 13, 2007.
(60) Provisional application No. 60/924,083, filed on Apr. 30, 2007.
(60) Provisional application No. 60/924,125, filed on May 1, 2007.
(60) Provisional application No. 61/006,094, filed on Dec. 19, 2007.
(60) Provisional application No. 61/006,095, filed on Dec. 19, 2007.
(60) Provisional application No. 61/006,097, filed on Dec. 19, 2007.
(60) Provisional application No. 61/006,099, filed on Dec. 19, 2007.
(60) Provisional application No. 61/006,100, filed on Dec. 19, 2007.
(60) Provisional application No. 61/006,098, filed on Dec. 19, 2007.

(51) Int. Cl. G06F 17/30

(52) U.S. Cl. 707/9; 707/104.1; 707/E17.005

(57) ABSTRACT

Systems, methods and computer program products for the processing, analysis and mining of physiological data within a wireless body area network are disclosed. The remote collection and monitoring of a person's (e.g., patient's) physiological data and activity levels for the purposes of determining the well-being of the person, as well as making additional health status determinations based on the historical information and trends of the collected data are provided. The systems, methods, and computer program products disclosed herein, in varying aspects, readily lend themselves to incremental component and functionality modifications, which allow for increased data sources, accuracy, reliability and utility of the collected information, further solidifying the uniqueness and desirability of the systems, methods and computer program products.

### CROSS-REFERENCE TO RELATED APPLICATIONS

This Application claims the benefit of, and is related to, the following of Applicants' co-pending applications:

U.S. Provisional Patent Application No. 60/900,987 titled “Physiological Data Processing Architecture for Situation Awareness,” filed on Feb. 13, 2007;

U.S. Provisional Patent Application No. 60/924,083, titled “Heterogeneous Data Collection and Data Mining Platform,” filed on Apr. 30, 2007;

U.S. Provisional Patent Application No. 60/924,125 titled “Heterogeneous Data Collection and Data Mining Platform” filed on May 1, 2007;

U.S. Provisional Patent Application No. 61/006,094, titled “Improved Communications and Biosensor Device,” filed on Dec. 19, 2007;

U.S. Provisional Patent Application No. 61/006,095, titled “Gateway for Discrete and Continuous Monitoring of Ambient Data with Emergency Functions,” filed on Dec. 19, 2007;

U.S. Provisional Patent Application No. 61/006,097, titled “Gateway for Discrete and Continuous Monitoring of Physiological Data,” filed on Dec. 19, 2007;

U.S. Provisional Patent Application No. 61/006,099, titled “Method and System for Discrete and Continuous Monitoring or Physiological and Ambient Data,” filed on Dec. 19, 2007;

U.S. Provisional Patent Application No. 61/006,100, titled “User Interface for System for Discrete and Continuous Monitoring of Physiological and Ambient Data,” filed on Dec. 19, 2007; and

U.S. Provisional Patent Application No. 61/006,098, titled “Method and System for Data Transmission for Use with Biosensor Device or Gateway,” filed on Dec. 19, 2007;

U.S. Non-provisional patent application Ser. No. ______, titled “System and Method for Physiological Data Readings, Transmission, and Presentation,”, filed on Jan. 25, 2008;

U.S. Non-provisional patent application Ser. No. ______, titled “System and Method for Physiological Data Readings, Transmission, and Presentation,”, filed on Feb. 5, 2008; and

U.S. Non-provisional patent application Ser. No. ______, titled “Body Patch for Non-Invasive Physiological Data Readings”, filed on Feb. 8, 2008, all incorporated by reference herein in entirety.

### BACKGROUND OF THE INVENTION

1. Field of the Invention

The present invention is generally related to automated systems, methods and computer program products for data processing, analysis and mining of human physiological data and activity levels. More particularly, the present invention relates to computing architectures, methods and computer program products for collecting, storing, processing, analyzing, securely transmitting and presenting a person's physiological data.

2. Related Art

Data processing is a well-established art in the computer field. Data processing generally refers to the processing of the actual raw data and it is customary to define a set of transformations on that data, to serve a specific purpose. This is accomplished through computer systems, custom and off-the-shelf algorithms (i.e., computer programs) and database systems. However, there are currently no available methods or systems that automatically monitor and supply enough data to a decision maker to make an informed judgment regarding the condition of the person being monitored following detection of variations in the person's physiological data.

### BRIEF DESCRIPTION OF THE INVENTION

The present invention meets the above-identified needs by providing methods, systems, and computer program products for data processing, analysis and mining of human physiological data and activity levels. The present invention also provides a decision support system to be used by consumers and care providers in the process of reaching conclusions on the general well-being of a particular individual.

An advantage of the present invention is that it provides decision support for the purposes of determining the well-being of a person.

Another advantage of the present invention is that it lends itself to population and drug studies as a result of the mined and collected data.

Another advantage of the present invention is that it has no limitation to the number and nature of physiological, location and activity sensors that it uses. The present invention can also be easily scaled to accommodate any number of sensors, thus resulting in increased accuracy, functionality and more data for data mining purposes.

Another advantage of the present invention is that it provides an analytical environment for raw and processed data analysis, which contributes to research and development advances in the fields of healthcare, drug discovery and related sciences.

Yet another advantage of the present invention is that it is well suited for consumer, clinical and business applications.

Further features and advantages of aspects of the present invention, as well as the structure and operation of these various aspects of the present invention, are described in detail below with reference to the accompanying drawings.

### BRIEF DESCRIPTION OF THE DRAWINGS

The features and advantages of aspects of the present invention will become more apparent from the detailed description set forth below when taken in conjunction with the claims and drawings, in which like reference numbers indicate identical or functionally similar elements. Additionally, the left-most digit of a reference number identifies the drawing in which the reference number first appears.

FIG. 1 is a high-level depiction of a system architecture according to an exemplary aspect of the present invention.

FIG. 2 is a block diagram showing a computer system according to an exemplary aspect of the present invention.

FIG. 3 is a high-level data and operational flow chart according to an exemplary aspect of the present invention.

FIG. 4 is an operational data analysis flow chart according to an exemplary aspect of the present invention.

FIG. 5 is a data analytics and data mining flow chart according to an exemplary aspect of the present invention.

### DETAILED DESCRIPTION

Aspects of the present invention are directed to systems, methods and computer program products for processing, analyzing and mining physiological data.

In an aspect of the present invention, a system for processing, analyzing and mining physiological data is disclosed. Such a system, in one aspect, includes a first tier of server(s). This first tier of server(s) is configured to enable interaction between the system and system user(s). The system user may be a subscriber to the system, a patient, a care giver, or a family member of an individual or person whose physiological data is being monitored by the system. The first tier of server(s) is also enabled to send alerts based on the system's analysis of the physiological data.

The system also includes a second tier of server(s), which are in operative communication or networked with the first tier of server(s). The second tier of server(s) is configured to respond to requests coming from the first tier of server(s), collect, analyze and process the physiological data, generate alerts based on the analysis of the physiological data and prepare the physiological data for storage. The second tier of server(s) is also enabled to respond to requests made by system user(s). Such requests may include requests for online analytics and data presentation. The system may also include a third tier of server(s), with this third tier of server(s) being in operative communication with the second tier of server(s). The third tier of server(s) is configured to define data models for the storage and retrieval of the physiological data and provide access to the physiological data. The third tier of server(s) is also configured to aggregate both raw and processed data. The third tier of server(s) may also serve as the storage for the physiological data.

In an aspect of the present invention, the system also includes a firewall which is in operative communication with the first and subsequent tier server(s).

In an aspect of the present invention, the system also includes an intrusion detection system which is in operative communication with the first and subsequent tier server(s) plus the firewall.

In an aspect of the present invention, the first tier of server(s) of the system is configured to receive physiological data from one or more external sources. In an aspect of the present invention, the first tier of server(s) of the system is configured to enable access to system user(s), authenticate the system user(s), enable system data analysis by the system user(s), enable display of system data to the system user(s) and enable editing of system data parameters and data by the system user(s). The system's authentication may be done by requiring the system user(s) to provide a password or some other identifying method or system. In another aspect of the present invention, the first tier of server(s) is further configured to receive data provided by the system user(s). The first tier of server(s) may also be configured to construct alerts based on data received from the system user(s).

In an aspect of the present invention, each or a number of the first, second and/or third tiers of server(s) may comprise of a processor, a display interface, with the display interface being in operative communication with the processor, a display unit, where the display unit is in operative communication with the display interface one or more memory components, the memory component(s) being in operative communication with the processor, and a communications interface where the communications interface is in operative communication with the processor.

In an aspect of the present invention, the first tier of server(s) is configured to communicate using the Internet, cellular connections, Voice-Over-Internet Protocol (VOIP) or wireless protocols. The wireless protocols may be one of Cellular, ZigBee, Wireless (802.11a/b/g/n), Wi-Fi, ANT, Bluetooth and Ultra Wide Band (UWB) protocols, etc.

In an aspect of the present invention, the second tier of server(s) is further configured to aggregate and normalize the physiological data.

In another aspect of the present invention, methods and computer program products perform the steps of identifying physiological data, determining the type of physiological data measured, categorizing the physiological data, analyzing the physiological data, and storing the physiological data. The physiological data may be either or a combination of ambient temperature, skin temperature, humidity, heart rate, physical activity, movement, location, blood pressure, blood-oxygen level, respiration and core body temperature of a system user. The physiological data may be stored for either operational data analysis or analytical data processing. The identification process may be done by creating an association between a system user and a unique identification for the system user, where the unique identification is contained within the physiological data.

In another aspect of the present invention, the method and computer program product perform the step of receiving the physiological data from a plurality of sources.

In another aspect of the present invention, the method and computer program product perform the step of determining the source of the physiological data.

In another aspect of the present invention, the method and computer program product perform the step of determining whether decryption of the physiological data is required. If decryption is required the method and computer program product then perform the step of decrypting the physiological data.

In another aspect of the present invention, the method and computer program product perform the step of anonymizing the physiological data.

In another aspect of the present invention, the method and computer program product perform the steps of monitoring and creating a historical database of the physiological data of the system user.

In another aspect of the present invention, the method and computer program product perform the step of determining variation(s) in the physiological data of the system user. The physiological data variation determination process may be conducted by comparing current and historical physiological data of the system user. The physiological data variation determination process may also include determining whether the variation(s) in the physiological data is within predefined normal variations in the physiological data.

In another aspect of the present invention, the method and computer program product perform the step of generating an alert when the variation(s) in the physiological data falls outside predefined normal variations in the physiological data.

In another aspect of the present invention, the method and computer program product perform the step of locating the system user. This may be done by using either the global positioning system (GPS) or cellular triangulation methods.

In another aspect of the present invention, the method and computer program product perform the step of preparing the physiological data for presentation and communication.

In another aspect of the present invention, the method and computer program product perform the step of determining whether it is time to transmit the physiological data based on a predetermined transmission schedule. The physiological data is aggregated if it is time to transmit.

In another aspect of the present invention, the method and computer program product perform the step of conducting trend analysis on the physiological data. The trend analysis may be conducted on one or a number of or a combination of different categories of physiological data.

In another aspect of the present invention, the method and computer program product perform the step of conducting demographic analysis on the physiological data. The demographic analysis process may involve selecting a basis for analysis, where the basis for analysis may be either or a combination of age, culture and geography. The demographic analysis process may further involve selecting one or more data points, where the data point(s) may be either or a combination of time, information, and prescription drug information, and analyzing the basis for analysis in context with the data point(s).

In another aspect of the present invention, the method and computer program product perform the step of conducting physiological data sensor analysis. The data sensor analysis process may involve selecting a category of physiological data, selecting a data class, and analyzing the category of physiological data in context with the data class. The different possible categories of physiological data include: ambient temperature, skin temperature, heart rate, physical activity, movement, location, blood pressure, blood-oxygen level, location and core body temperature of a system user.

In another aspect of the present invention, the method and computer program product perform the step of enabling access to the system for one or more system users, authenticating the system user(s), enabling system data analysis by the system user(s), enabling display of system data to the system user(s), and enabling editing of system data parameters and data by the system user(s).

Aspects of the present invention will now be described in more detail herein in terms of the above exemplary context and the accompanying figures. This description is for convenience only and is not intended to limit the application of aspects of the present invention. In fact, after reading the following description, it will be apparent to those skilled in the relevant art(s) how to implement aspects of the following invention in alternative ways.

The terms “person,” “patient,” “individual”, “subject,” “user,” “subscriber,” “client,” “being,” “system user” and/or the plural form of these terms are sometimes used interchangeably herein to refer to those person(s) or other living being(s) from whom physiological data are being collected (or, in some cases, the safety and medical personnel and professionals entrusted with their well being), and thus would benefit from the systems, methods, and computer program products that aspects of the present invention provide for facilitating the receipt, collection, storage, transmission, and presentation of physiological data of persons or other living beings.

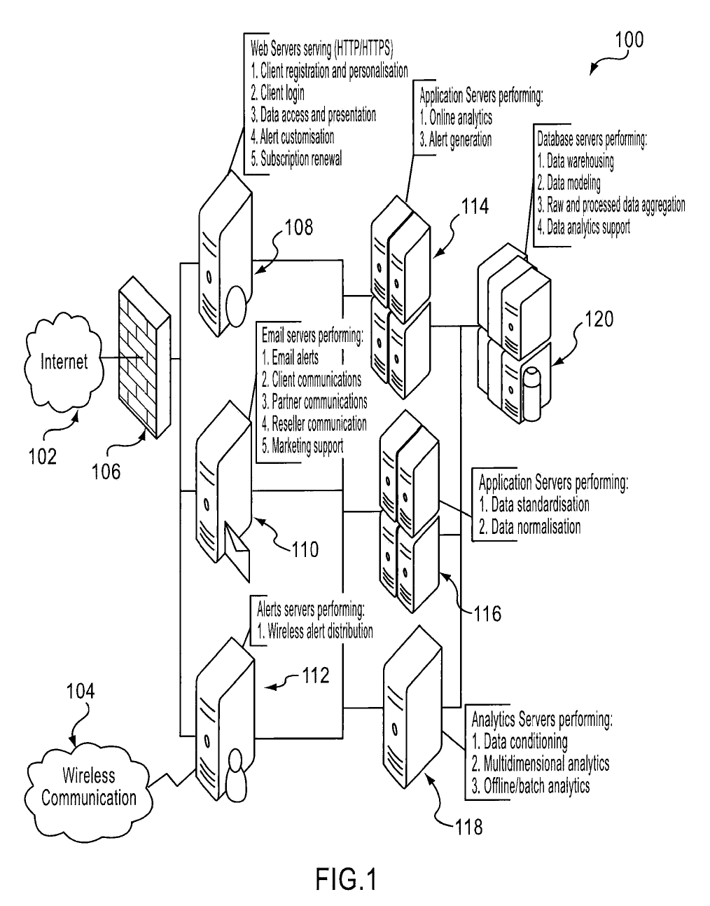

Referring now to FIG. 1, a general depiction of system architecture 100 according to an aspect of the present invention is shown. This represents the primary hardware components of system architecture 100.

System architecture 100 defines two methods of communicating with external devices and users: one through Internet 102, which is used for incoming data from the collection devices and for providing user access to the data; and one through a wireless (most commonly cellular) network 104, which is used for outgoing alerts and other notification messages destined for the call center and subscribers.

All traffic from Internet 102 is routed through a firewall 106 which is configured such that only authorized connections can gain access to system 100 and its data. The purpose of firewall 106 is to provide security and restrict unauthorized access to system 100 and client data. Behind the firewall there is also an intrusion detection system (IDS), not shown in FIG. 1. The intrusion detection system provides another defense barrier against unauthorized access.

System architecture 100 represents a typical multi-tier environment, depicted here as having three tiers, where different functions and different levels of control are implemented at each tier. It should be noted that one or more servers may perform the tasks within each tier. In FIG. 1, the first tier represents outward facing functions. These include web servers 108 for the presentation layer of the application and system 100 subscriber portal. Web servers 108 enable subscribers to authenticate, manage subscriptions, define profiles, and gain access to the collected data and the reporting capabilities. Email servers 110 make up an additional component of this tier. Email servers 110 are used for communicating with subscribers, care givers, and business partners.

The first tier also contains alerts servers 112, which construct and transmit alerts based on the combination of analysis on a subscriber's data and the corresponding personalized profile settings. Transmission of alerts is accomplished primarily through cellular connections and through other protocols like wireless, voice over Internet protocol (IP) (VoIP) and so on. Any number of protocols may be used, the majority of which specify an operating frequency range. Other protocols may operate on a single frequency. In alternate aspects, transmission protocols may include ZigBee (802.15.4), Cellular (CDMA, TDMA, GSM and others), Wireless (802.11a/b/g/n), Wi-Fi (802.11 p), ANT, Bluetooth (802.15.1), or custom wireless protocols working in any available frequency or frequencies.

The second tier of system architecture 100 consists of application servers 114 which are responsible for performing the majority of processing on the data and responding to requests coming from the previous tier. A set of application servers 114 is assigned to perform analysis of incoming data and generate any alerts based on the analysis, plus process subscriber requests for online analytics and data presentation. This is effectively the decision support element of system architecture 100, empowering subscribers to formulate action plans based on the analysis of the collected data. A second set of application servers 116 is responsible for aggregating all the data, normalizing it and preparing the data for storage in the data warehouse and for analysis, whether online or offline (batch). A third set of application servers 118 is responsible for all the data processing and data analytics.

The third tier of system architecture 100 contains the data collected, which are housed in a data warehouse. Here database servers 120 define data models for data storage and retrieval and is the access point into the data. The security level is at its highest at this tier in order to detect and safeguard against unauthorized access.

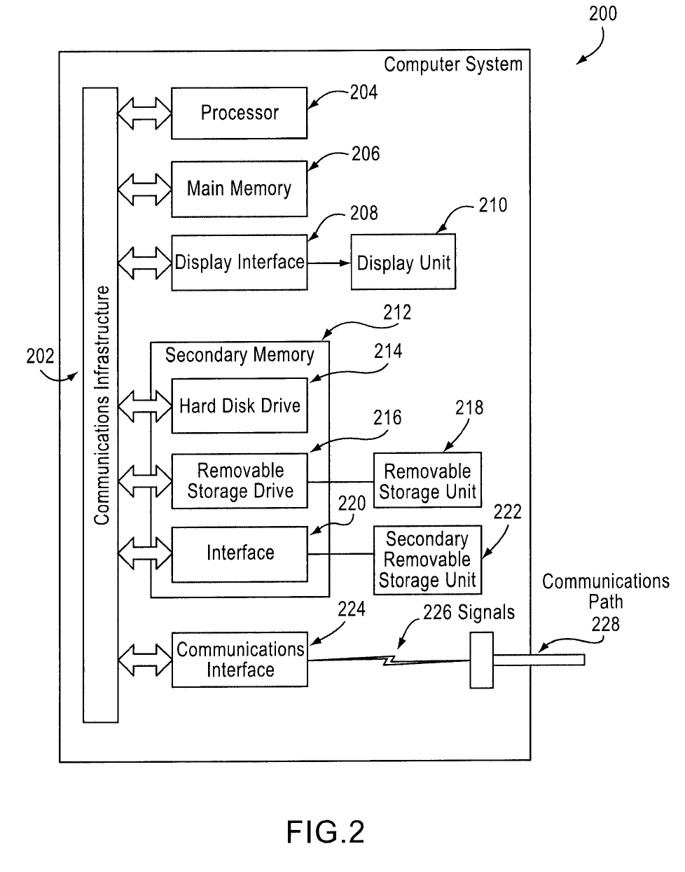

System architecture 100 describes a number of servers, which in effect are computer systems similar to the block diagram in FIG. 2, depicting various computer system components for use with an exemplary implementation of a data collection, analysis, storage, presentation, distribution, and communications system, in accordance with an aspect of the present invention.

Referring now to FIG. 2, a computer system 200 depicting various computer system components for use with an exemplary implementation of a data collection, communications and analysis device, in accordance with an aspect of the present invention is shown.

Various software aspects are described in terms of this exemplary computer system. After reading this description, it will become apparent to a person skilled in the relevant art(s) how to implement the invention using other computer systems and/or architectures.

The computer system 200 includes one or more processors, such as processor 204. Processor 204 is connected to a communications infrastructure 202 (e.g., a communications bus, cross-over bar, or network). Computer system 200 can include a display interface 208 that forwards graphics, text, and other data from the communication infrastructure 202 (or from a frame buffer not shown) for display on display unit 210.

Computer system 200 also includes a main memory 206, preferably random access memory (RAM), and may also include a secondary memory 212. The secondary memory 212 may include, for example, a hard disk drive 214 and/or a removable storage drive 216, representing a floppy disk drive, a magnetic tape drive, an optical disk drive, etc. The removable storage drive 216 reads from and/or writes to a removable storage unit 218 in a well known manner. Removable storage unit 218 represents a floppy disk, magnetic tape, optical disk, etc. which is read by and written to by removable storage drive 216. As will be appreciated, the removable storage unit 218 includes a computer usable storage medium having stored therein computer software and/or data.

In alternative aspects, secondary memory 212 may include other similar devices for allowing computer programs or other instructions to be loaded into computer system 200. Such devices may include, for example, a secondary removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other secondary removable storage units 222 and interfaces 220, which allow software and data to be transferred from the secondary removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 226 which may be electronic, electromagnetic, optical or other signals capable of being received by communications interface 224. These signals 226 are provided to communications interface 224 via a communications path (e.g., channel) 228. This channel 228 carries signals 226 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 216, a hard disk installed in hard disk drive 214, and signals 226. These computer program products provide software to computer system 200. The invention is directed to such computer program products.

Computer programs (also referred to as computer control logic) are stored in main memory 206 and/or secondary memory 212. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an aspect where the invention is implemented using software, the software may be stored in a computer program product and loaded into computer system 200 using removable storage drive 216, hard drive 214 or communications interface 224. The control logic (software), when executed by the processor 204, causes the processor 204 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s.

In yet another aspect, the present invention is implemented using a combination of both hardware and software.

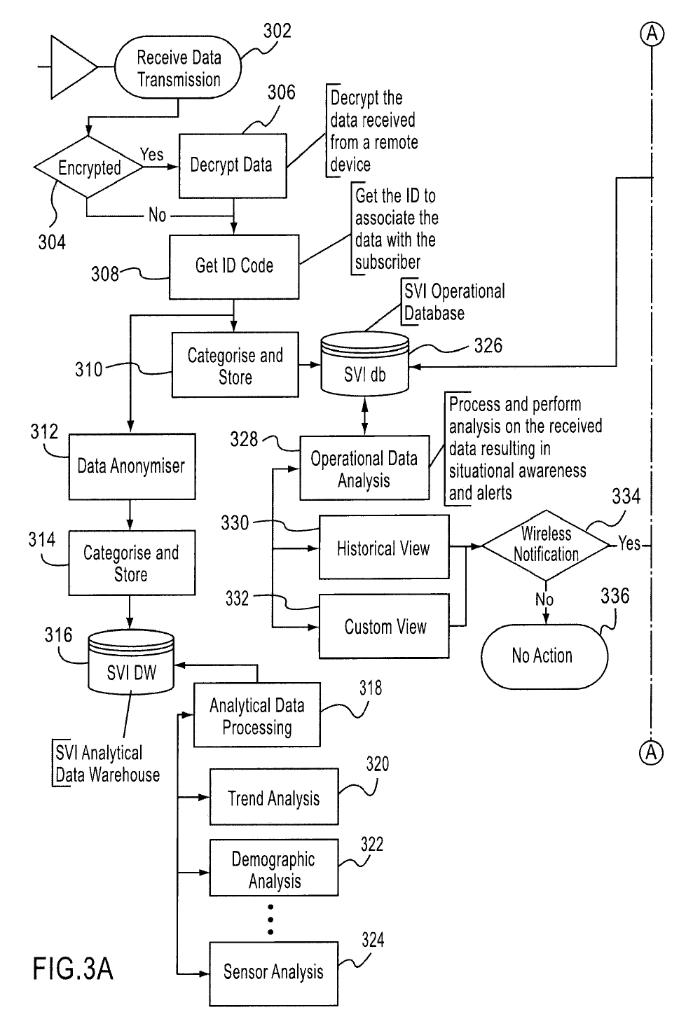

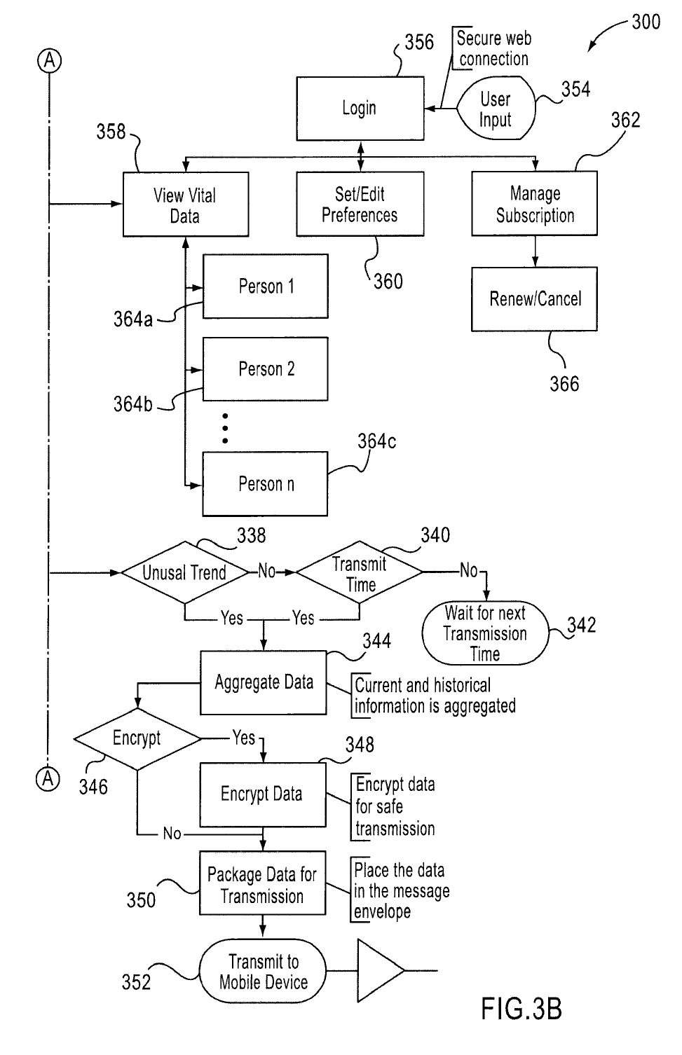

Referring now to FIG. 3, a data and operational flow 300 according to an aspect of the present invention is shown. (System architecture 100 also describes a number of data flows and operations on the data, which enhance the value of the data collected and transmitted to a data center.) FIG. 3 provides an overall pictorial representation of data flow 300, indicating where data transformations occur. It is important to note that there are two entry and two exit points in data flow 300. The two entry points are depicted by “Receive Data Transmission” (block 302) and “User Input” (block 354). Block 302 is only an entry point and represents the path used for receiving data transmitted from remote devices. Block 354 is both an entry and exit point, representing a user interface for user interaction with the system. The two exit points are depicted by the “User Input” (block 354) and “transmit to Mobile Device” (block 352). Block 352 is only an exit point and is used for transmitting information to remote devices, which may include smart cell-phones, and personal digital assistants (PDAs).

First a description of the data flow from block 302 or “Receive Data Transmission” point is provided. As stated, this is the entry point for receiving data transmitted from remote devices. When the data arrives, the first check performed is to determine, in step 304, whether it is encrypted or not. It is common to encrypt transmitted data for increased security. If the data is encrypted, the proper decryption algorithms in step 306 are used to decrypt the data so the data can be processed further. If the data is not encrypted, then decryption step 306 is bypassed. The next step is to identify the data in step 308. Identification means to create an association between the transmitted data and a subscriber. Since the data is transmitted without specific identifying information other than a unique ID, this unique ID is used to cross-reference with the subscribers in order to make the association.

At this point data flow 300 splits into two separate paths, each describing a different use case for the data. One path directly supports subscriber operations and the other addresses the needs for analytical processing and data warehousing.

Following the association between the received data and a subscriber in step 308, computer programs resident on system architecture 100 examine the data to determine the collection source, as it relates to the type of data, what it measures (temperature, motion, heart rate, etc.), the time period covered and separate the data into those categories. This then enables storing the data in the operational database in step 326 for follow-on analysis.

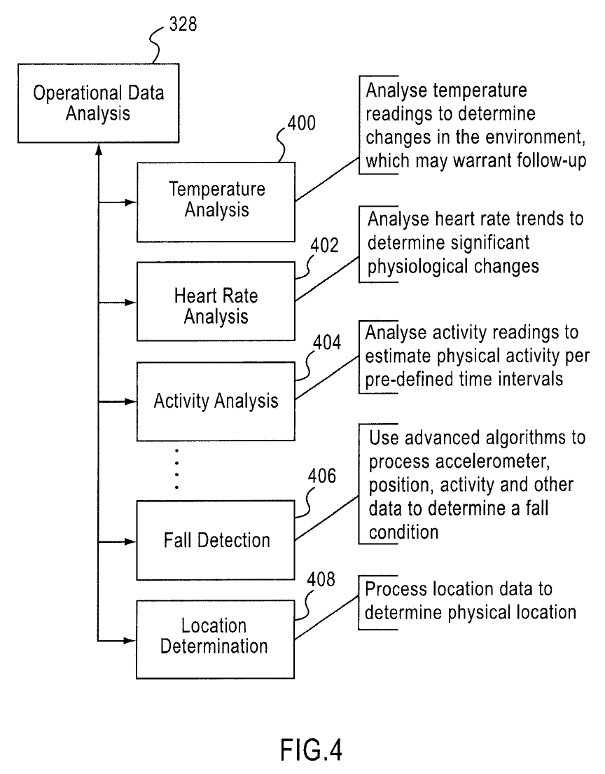

Referring now to FIG. 4, an expanded detail of the main elements of the operational analysis data flow according to an aspect of the present invention is shown.

Analysis of the data is controlled by the Operational Data Analysis process in step 328, which knows the classes of physiological data collected and can initiate the corresponding data class analysis and related data fusion analysis. FIG. 4 includes five physiological data classes: temperature, heart rate, activity, accelerometer movement (i.e., fall detection) and location (i.e., geospatial positioning). A number of other physiological data classes may be collected and included in the operational data analysis, including blood pressure, blood-oxygen level, core body temperature and others.

Temperature Analysis in step 400 makes use of both current and historical temperature information, to determine ambient and skin temperature variations. Significant changes to the readings may be cause for concern, indicating severe environmental changes, which may need to be addressed.

Heart Rate Analysis in step 402 makes use of both current and historical heart rate data, in order to identify variations from the established normal range. Significant variance, as defined by a physician, may be a cause for alarm, indicating a change in a person's physiology, which may be concerning.

Activity Analysis in step 404 uses current and historical data along with profile information to create a running history of a person's activity over time. This can often indicate how active a person has been, as determined by the number of steps walked, which is then translated to real distance. Profile information would define the step length, much like the configurations for a pedometer, and may also define minimum and maximum activity levels for a defined period of time. All those parameters can then be used to evaluate whether a person has had adequate activity (exercise).

Fall Detection in step 406 makes use of current and near-term accelerometer data and complex computer algorithms to process the data and determine whether there has been a significant acceleration event, not consistent with normal activity. Should such an event be detected, follow-on data would reinforce the conclusion, usually due to decreased or no-motion data. This would be cause for alarm and close monitoring of the situation may be required.

Location Determination in step 408 uses current data to identify the geospatial location of a person. Through the use of the Global Positioning System (GPS) or transmission triangulation technology the location of a person can be determined. Historical data may also show where a person has traveled.

After the analysis of the data is performed in step 328, the data flow continues, as shown in FIG. 3. At this point the analysis results need to be prepared for presentation and communication. For presentation purposes two views are created: a historical view in step 330, which includes all data from the earliest date system 100 was used by this user; and a current view in step 332, which includes data for the time period defined in the user profile. The rest of data flow 300 is driven by the user's level of service and profile.

One of the options is for a user to receive notifications to wireless devices in step 334, for variations in the data, based on levels defined in the user profile. Thus, if receiving such notifications is not part of the service level for a user, no further action is taken in step 336 and the data flow terminates. If the service level includes wireless notifications, then the processing continues and the notification messages are created and sent.

System 100 then checks whether there are variations in the data in step 338, to warrant an immediate transmission. If that is not the case, system 100 in step 340 checks whether it is time to initiate a transmission, based on a predefined transmission schedule. If it is not time for transmission, system 100 will wait in step 342 until the next transmission time or an out of sequence alert event, to start the transmission process again.

If it is time to send a transmission or there is a need to initiate an out-of-sequence transmission due to the data analysis, then the data flow follows those steps. First, the pertinent data is aggregated in step 344. This includes the data readings and the analysis results, so that the user receiving this information can formulate an educated decision as to the next steps and actions to be taken.

Following the aggregation of all the data and results in step 344, system 100 checks, in step 346, to see whether the user device can handle encrypted data which is driven by the user profile. In the user profile, the user defines whether encrypted data transmissions can be processed properly. In addition, in the user profile, the user sets the encryption algorithm to be used. Thus, if encryption is to be used, the data is encrypted in step 348, before going to the next step.

Now that the data and the message content are ready, the message itself needs to be assembled for transmission. In step 350, the message envelope and header information are wrapped around the content, so that the transmission protocol to be used for sending the message can accurately route the message to the intended recipient. As soon as the message is ready, it is transmitted through the network in step 352, to arrive at the defined destination.

Following the association between the received data and a subscriber in step 308, the data is anonymised (i.e., all personal identifiable information is removed) in step 310, while maintaining demographic information. Through the association of the data to a subscriber in step 308, all the demographic information about this subscriber is known. To anonymise the data in step 310, identifying information such as name, address, phone number, Social Security Number or other identification numbers, are removed from the data, leaving only the physiological readings and the demographic data (e.g., sex, race/culture, geography, age, etc.). Application servers 116 then examine the data to determine the collection source, as it relates to the type of data, what it measures (temperature, motion, heart rate, etc.), the time period covered, as in time of day, and separate the data into those categories in step 314. This then enables storing, also in step 314, the data in the analytical data warehouse 316 for follow-on analysis. An aspect of the invention includes the ability to determine at least the manufacturer and model of either a gateway device or a body patch device. The anonymous data may also include a collection of data corresponding to a particular manufacturer or model of these devices. This allows an analysis to be made of the quality of service provided by these devices.

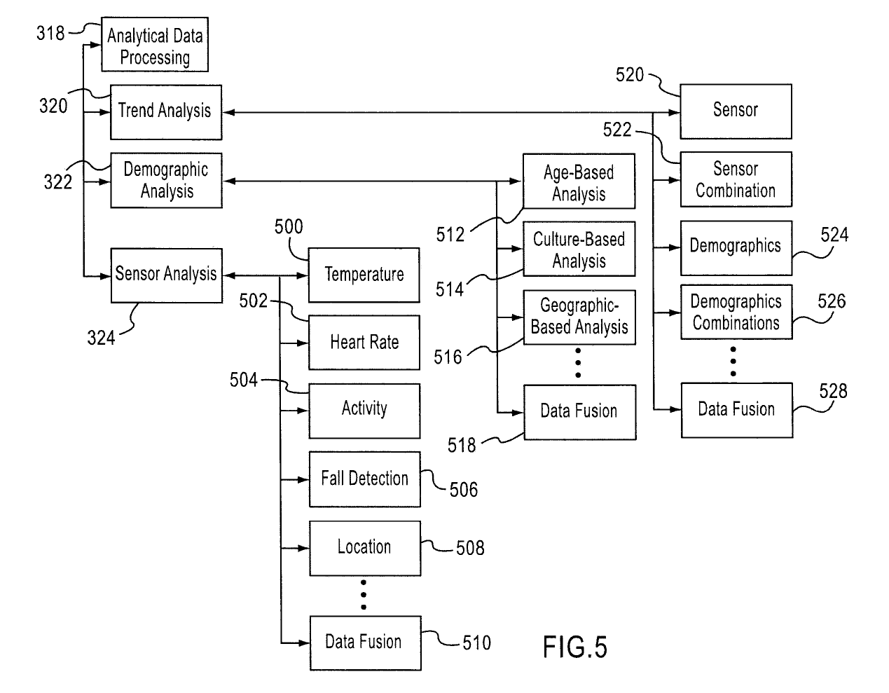

Once the data is available, analytical data processing in step 318 (shown in more detail in FIG. 5) takes place. Analytical data processing 318 defines the operations on the anonymised data, to support non-consumer uses, including product enhancements, research and development, population and age studies, and drug discovery. Analytical data processing in step 318 includes operations and transformations on the data in the data warehouse and makes use of complex data schemas and analytical stores (also referred to as data cubes), plus complex computer algorithms. FIG. 5 depicts only a small subset of the possible set of analytical processing.

One type of analysis is Trend Analysis as shown in block 320. Trend analysis is used for identifying patterns in the data over time, with the objective of associating trends to certain events. The trend analysis can define operations on a single source or multiple data sources, and also combine all available data to reach results contributing to decision support. The Trend Analysis data flow in FIG. 5 depicts analysis based on a single sensor source (block 512), a combination of sensors (block 514) or a single demographic data point—for example age (block 516), a combination of demographics—for example age and gender (block 518). Data Fusion (block 520) may also be used for trend analysis, which makes use of all the available data classes and data sources, including many more categories than those shown in the FIG. 5.

Demographic Analysis, shown in block 322, defines another set of operations on the data, from the perspective of demographic data. Demographic analysis starts with one or multiple demographic data classes as the base of analysis and then adds additional data points, from the available set of data. As depicted in the FIG. 5, analysis may start based on age as shown in block 512, culture as shown in block 514, geography as shown in block 516, or data fusion as shown in block 520. Data fusion makes use of all the available data classes and data sources, including many more categories than those shown in the FIG. 5. Demographic analysis may make use of all available data classes and then expand by introducing additional data like one or more sensors, time information, prescription drug information, etc. This analysis would provide a view into how a particular population segment reacts based on a physiological reading or the use of some drug, etc.

For example, one aspect of the invention may include conducting a medication impact study and analysis, wherein said medication impact study includes selecting at least one category of physiological data, wherein said category of physiological data is one selected from a group consisting of ambient temperature, humidity, skin temperature, heart rate, physical activity, movement, location, blood pressure, blood-oxygen level, respiration, location and core body temperature of a system user; selecting a data class; selecting at least one medications used by a demographic group; and analyzing said category of physiological data in context with said data class and said at least one medication.

Sensor Analysis as shown in block 324, starts with one or more sensor data such as temperature data (block 500), heart rate data (block 502), activity levels (block 504), fall detection data (block 506), location data (block 508) and data fusion data (block 510), as the basis for analysis. From there, additional data classes are added, to create more value for the analysis results. Other data classes, including demographic, time of day, and even external to the system information, like weather data, may be added to drive analysis results. This type of analysis may be used for sensor development and enhancement, new algorithms for sensor data processing, sensitivity improvement, or even new sensor types.

The second entry point to the data flow, in FIG. 3, is through User Input shown as block 354, which is also an exit point, since information is returned back to the user. This is also an interactive data flow. The data flow is initialized by a user who accesses the secure web site in step 356 to get information, perform analysis or some other action. That is commonly done through a secure web browser connection. Once connected and authenticated to the site, a user has a number of options, including: Manage Subscription in step 362, Set/Edit Preferences in step 360, and View Vital Data in step 358. Through managing the subscription in step 362, a user can renew or cancel the service in step 366, set a different service level, or choose additional options. Through setting or editing preferences in step 360, a user effectively defines the profile to be used for data analysis. This includes settings and thresholds for alerts and conditions triggering them, notification preferences, notification list, contact information.

A user can also view vital data in step 358. Since a user may be monitoring multiple persons, access to those analyses is through the respective person section, indicated in FIG. 3 as Person 1, Person 2 . . . Person n shown as blocks 364a, 364b, . . . 364n, respectively. Through those sections the user can access the vital data and displays for a person and can view current data and historical trends for each person in the subscription. The system user may also use this information to adjust preferences, alerts and notification levels. Through this data flow, a user obtains a complete update on all available vital signs data collected, aggregated and transmitted by the sensor system. This results in situational awareness of a person's condition at any given point in time and provides decision support for any follow-on actions.

While various aspects of the present invention have been described above, it should be understood that they have been presented by way of example, and not limitation. It will be apparent to persons skilled in the relevant art(s) that various changes in form and detail can be made therein without departing from the spirit and scope of aspects of the present invention. Thus, aspects of the present invention should not be limited by any of the above described exemplary aspects, but should be defined only in accordance with the following claims and their equivalents.

In addition, it should be understood that the figures in the attachments, which highlight the structure, methodology, functionality and advantages of aspects of the present invention, are presented for example purposes only. Aspects of the present invention are sufficiently flexible and configurable, such that it may be implemented in ways other than that shown in the accompanying figures.

Further, the purpose of the foregoing Abstract is to enable the U.S. Patent and Trademark Office and the public generally, and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of aspects of the present invention in any way.

What is claimed is:

1. A system for processing, analyzing and mining physiological data comprising:
a. a first tier of at least one server;
b. a second tier of at least one server, in operative communication with said first tier of at least one server, wherein said second tier of at least one server is configured to:
i. respond to at least one request from said first tier of at least one server;
ii. collect, analyze and process said physiological data;
iii. generate alerts based on said analysis of said physiological data; and
iv. prepare said physiological data for storage;
c. a third tier of at least one server, in operative communication with said second tier of at least one server wherein said third tier of at least one server is configured to:
i. define data models for the storage and retrieval of said physiological data;
ii. provide access to said physiological data; and
iii. aggregate raw and processed physiological data.

2. The system of claim 1, further comprising a firewall in operative communication with at least one of said first tier, said second tier, and said third tier of at least one server.

3. The system of claim 1, further comprising an intrusion detection system in operative communication with said first tier said second tier, said third tier, and said firewall of at least one server.

4. The system of claim 1, wherein said first tier of at least one server is further configured to communicate with one of: a system subscriber, a care giver, and a business partner.

5. The system of claim 4, wherein said first tier of at least one server is configured to communicate via one of: Internet, cellular connections, Voice-Over-Internet Protocol (VOIP) and wireless protocol.

6. The system of claim 5, wherein said wireless protocols is one of: Cellular, ZigBee, Wireless (802.11a/b/g/n), Wi-Fi, ANT, Bluetooth and Ultra Wide Band (UWB).

7. The system of claim 1, wherein said first tier of at least one server is further configured to enable interaction between said system and at least one system user.

8. The system of claim 7, wherein said first tier of at least one server is further configured to:
a. enable access to said at least one system user;
b. authenticate said at least one system user;
c. enable system data analysis by said at least one system user;
d. enable display of system data to said at least one system user; and
e. enable editing of system data parameters and data by said at least one system user.

9. The system of claim 8, wherein said first tier of at least one server is further configured to receive data provided by said at least one system user.

10. The system of claim 9, wherein said first tier of at least one server is further configured to construct alerts based on data received from said at least one system user.

11. The system of claim 1, wherein said first tier of at least one server comprises:
a. a processor;
b. a display interface, the display interface being in operative communication with the processor;
c. a display unit, the display unit being in operative communication with the display interface;
d. at least one memory component, said at least one memory component being in operative communication with the processor; and
e. a communications interface, the communications interface being in operative communication with said processor.

12. The system of claim 1, wherein said second tier of at least one server is further configured to aggregate and normalize said physiological data.

13. The system of claim 1, wherein said second tier of at least one server is further configured to respond to at least one request from at least one system user.

14. A method for processing, analyzing and mining physiological data in a system comprising:
a. identifying physiological data;
b. determining the type of physiological data measured;
c. categorizing said physiological data;
d. analyzing said physiological data; and
e. storing said physiological data.

15. The method of claim 14, further comprising receiving said physiological data from a plurality of sources.

16. The method of claim 15, further comprising determining the source of said physiological data.

17. The method of claim 14, further comprising determining whether decryption of said physiological data is required.

18. The method of claim 17, further comprising decrypting said physiological data if decryption is required.

19. The method of claim 14, further comprising anonymizing said physiological data.

20. The method of claim 14, wherein said physiological data is stored for one of: operational data analysis and analytical data processing.

21. The method of claim 14, wherein step (a) comprises creating an association between a system user and a unique identification for said system user, wherein said unique identification is contained within said physiological data.

22. The method of claim 14, wherein said physiological data is one of: ambient temperature, humidity, skin temperature, heart rate, physical activity, movement, location, blood pressure, blood-oxygen level, respiration, location and core body temperature of a system user.

23. The method of claim 22, further comprising: monitoring and creating a historical database of said physiological data of said system user.

24. The method of claim 22, further comprising determining at least one variation in said physiological data of said system user, wherein determining at least one variation in said physiological data of said system user comprises comparing current and historical physiological data of said system user.

25. The method of claim 24, further comprising determining whether said at least one variation in said physiological data is within predefined normal variations in said physiological data.

26. The method of claim 25, further comprising generating an alert when said at least one variation in said physiological data falls outside predefined normal variations in said physiological data.

27. The method of claim 22, further comprising locating said system user using one of: global positioning system (GPS) and cellular triangulation methods.

28. The method of claim 22, further comprising preparing said physiological data for presentation and communication.

29. The method of claim 14, further comprising determining whether it is time to transmit said physiological data based on a predetermined transmission schedule.

30. The method of claim 29, further comprising aggregating said physiological data if it is time to transmit.

31. The method of claim 14, further comprising conducting trend analysis on said physiological data.

32. The method of claim 31, wherein said trend analysis is conducted on a combination of different categories of said physiological data.

33. The method of claim 14, further comprising conducting demographic analysis on said physiological data wherein said demographic analysis comprises:
a. selecting a basis for analysis, wherein said basis for analysis is one of: age, culture and geography;
b. selecting at least one data point, wherein said at least one data point is one of: time, information, and prescription drug information; and
c. analyzing said basis for analysis in context with said at least one data point.

34. The method of claim 14, further comprising conducting physiological sensor data analysis wherein said sensor data analysis comprises:
a. selecting a category of physiological data, wherein said category of physiological data is one of: ambient temperature, humidity, skin temperature, heart rate, physical activity, movement, location, blood pressure, blood-oxygen level, respiration, location and core body temperature of a system user;
b. selecting a data class; and
c. analyzing said category of physiological data in context with said data class.

35. The method of claim 14, further comprising conducting a medication impact study and analysis, wherein said medication impact study includes:
a. selecting at least one category of physiological data, wherein said category of physiological data is one selected from a group consisting of ambient temperature, humidity, skin temperature, heart rate, physical activity, movement, location, blood pressure, blood-oxygen level, respiration, location and core body temperature of a system user;
b. selecting a data class;
c. selecting at least one medications used by a demographic group; and
d. analyzing said category of physiological data in context with said data class and said at least one medication.

36. The method of claim 14, further comprising
a. enabling access to said system by at least a system user;
b. authenticating said at least one system user;
c. enabling system data analysis by said at least one system user;
d. enabling display of system data to said at least one system user; and
e. enabling editing of system data parameters and data by said at least one system user.

37. A computer program product comprising a computer usable medium having control logic stored therein for causing a computer to process, analyze and mine physiological data, said control logic comprising:
a. first computer readable program code means for causing the computer to identify physiological data;
b. second computer readable program code means for causing the computer to determine the type of physiological data measured;
c. third computer readable program code means for causing the computer to categorize said physiological data;
d. fourth computer readable program code means for causing the computer to analyze said physiological data; and
e. fifth computer readable program code means for causing the computer to store said physiological data.

38. The computer program product of claim 37, further comprising sixth computer readable program code means for causing the computer to receive said physiological data from a plurality of sources.

39. The computer program product of claim 38, further comprising seventh computer readable program code means for causing the computer to determine the source of said physiological data.

40. The computer program product of claim 37, further comprising sixth computer readable program code means for causing the computer to determine whether decryption of said physiological data is required.

41. The computer program product of claim 40, further comprising seventh computer readable program code means for causing the computer to decrypt said physiological data.

42. The computer program product of claim 37, further comprising sixth computer readable program code means for causing the computer to anonymize said physiological data.

43. The computer program product of claim 37, wherein said physiological data is stored for one of: operational data analysis and analytical data processing.

44. The computer program product of claim 37, wherein said first computer readable program code means comprises control logic for creating an association between a system user and a unique identification for said system user, wherein said unique identification is contained within said physiological data.

45. The computer program product of claim 37, wherein said physiological data is one of: ambient temperature, humidity, skin temperature, heart rate, physical activity, movement, location, blood pressure, blood-oxygen level, respiration, location and core body temperature of a system user.

46. The computer program product of claim 45, further comprising sixth computer readable program code means for causing the computer to monitor and create a historical database of said physiological data of said system user.

47. The computer program product of claim 45, further comprising sixth computer readable program code means for causing the computer to determine at least one variation in said physiological data of said system user, wherein determining at least one variation in said physiological data of said system user comprises comparing current and historical physiological data of said system user.

48. The computer program product of claim 47, further comprising seventh computer readable program code means for causing the computer to determine whether said at least one variation is within predefined normal variations in said physiological data.

49. The computer program product of claim 48, further comprising eighth computer readable program code means for causing the computer to generate an alert when said at least one variation in said physiological data falls outside predefined normal variations in said physiological data.

50. The computer program product of claim 45, further comprising sixth computer readable program code means for causing the computer to locate said system user using one of: global positioning system (GPS) and cellular triangulation methods.

51. The computer program product of claim 45, further comprising sixth computer readable program code means for causing the computer to prepare said physiological data for presentation and communication.

52. The computer program product of claim 37, further comprising sixth computer readable program code means for causing the computer to determine whether it is time to transmit said physiological data based on a predetermined transmission schedule.

53. The computer program product of claim 52, further comprising seventh computer readable program code means for causing the computer to aggregate said physiological data if it is time to transmit.

54. The computer program product of claim 37, further comprising sixth computer readable program code means for causing the computer to conduct trend analysis on said physiological data.

55. The computer program product of claim 54, wherein said trend analysis is conducted on a combination of different categories of said physiological data.

56. The computer program product of claim 37, further comprising sixth computer readable program code means for causing the computer to conduct demographic analysis on said physiological data wherein said sixth computer readable program code means comprises:
a. seventh computer readable program code means for causing the computer to select a basis for analysis, wherein said basis for analysis is one of: age, culture and geography;
b. eighth computer readable program code means for causing the computer to select at least one data point, wherein said at least one data point is one of: time, information, and prescription drug information; and
c. ninth computer readable program code means for causing the computer to analyze said basis for analysis in context with said at least one data point.

57. The computer program product of claim 37, further comprising sixth computer readable program code means for causing the computer to conduct physiological data sensor analysis wherein said sixth computer readable program code means comprises:
a. seventh computer readable program code means for causing the computer to select a category of physiological data wherein said category of physiological data is one of: ambient temperature, humidity, skin temperature, heart rate, physical activity, movement, location, blood pressure, blood-oxygen level, respiration, location and core body temperature of a system user;
b. eighth computer readable program code means for causing the computer to select a data class; and
c. ninth computer readable program code means for causing the computer to analyze said category of physiological data in context with said data class.

58. The computer program product of claim 37, further comprising:
a. sixth computer readable program code means for causing the computer to enable access to said system by at least one system user;
b. seventh computer readable program code means for causing the computer to authenticate said at least one system user;
c. eighth computer readable program code means for causing the computer to enable system data analysis by said at least one system user;
d. ninth computer readable program code means for causing the computer to enable display of system data to said at least one system user; and
e. tenth computer readable program code means for causing the computer to enable editing of system data parameters and data by said at least one system user.
